(19) United States
(12) Patent Application Publication
(10) Pub. No.: US 2017/0020192 A1
(43) Pub. Date: Jan. 26, 2017

(54) CONTROLLED FEEDING DEVICE OF THE WICK OF AN E- CIGARETTE, E-CIGARETTE OBTAINED

(71) Applicant: INNOVI, Moncaut (FR)

(72) Inventors: Alexandra Fregonese, Moncaut (FR); Richard Fregonese, Moncaut (FR); Alexandre Eveillard, Moirax (FR)

(21) Appl. No.: 14/833,591

(22) Filed: Aug. 24, 2015

(30) Foreign Application Priority Data
Jul. 20, 2015 (FR) 1556853

(51) Int. Cl. A24F 47/00; H05B 3/02

(52) U.S. Cl. CPC A24F 47/008; H05B 3/026

(57) ABSTRACT

A device for feeding e-liquid in an e-cigarette, comprising a vaporization zone with at least one wick and a resistor, a reservoir of e-liquid, and a battery for supplying electrical energy to at least the resistor. The device comprises at least one micro pump interposed between the reservoir and the wick. An e-cigarette incorporating the feeding device is also disclosed.

### CROSS-REFERENCES TO RELATED APPLICATIONS

This application claims the benefit of the French patent application No. 1556853 filed on Jul. 20, 2015, the entire disclosures of which are incorporated herein by way of reference.

### BACKGROUND OF THE INVENTION

The present invention generally relates to a spray head for an inline mixer for mixing multiple components of a combined fluid stream.

Inline mixing of combined fluid streams, including fluid streams of different viscosities, may be useful in a wide variety of settings including the medical field. In one example of an application in the medical field, inline mixing of two or more combined fluid streams is employed to form a sealant, such as a tissue sealant, that is applied to human and animal tissue. Such sealant may be employed to seal or repair tissue at a surgical or wound site, to stop bleeding, seal wounds, treat burns or skin grafts and a variety of other purposes.

The present invention is a controlled feeding device of an e-cigarette in e-liquid.

The invention also covers the e-cigarette obtained.

Cigarettes made from tobacco whose combustion releases a smoke inhaled by smokers are known in the prior art.

The combustion of tobacco releases smoke made up of many compounds, some of which are harmful to health.

However, tobacco consumption is slightly decreasing, if at all, and palliatives to smoking have always been sought.

Solutions have been devised to limit consumption with patches affixed to the body to diffuse some of the usual compounds of a cigarette, but all tests have encountered major obstacles, including that of behavioral ritual, conviviality and the sensations provided by cigarettes, including the effects of well-being and relaxation associated with some of the volatile compounds carried in the smoke.

A palliative designed to reduce tobacco use is proposed in the form of an e-cigarette. An e-cigarette is a mobile device, fully contained in an elongated casing which may remind one of a cigarette, and comprising a reservoir for a composition to be vaporized, a heating zone for vaporizing at least a portion of said composition with at least a wick, a resistor and a mouthpiece, a battery for supplying electric power to the resistor, a control switch for said resistor being provided to vaporize the composition on demand.

Complementarily, the wick is immersed in the reservoir and the resistor of the heating zone surrounds a portion of said wick, outside said reservoir. The temperature rise of the resistor ensures vaporization of the composition.

The composition is perfectly balanced, on demand, and includes compounds, volatile in the heat, of glycerol and perfume types, but also nicotine in order to incorporate at least part of the sensations of the cigarette. The first advantage is to be able to dose the compounds on demand and therefore to individualize the composition according to the user.

As the system is based on vaporization, there is no combustion, and especially no production of particularly harmful tars from tobacco. The compositions being prepared from a mixture, it is possible to perfectly adjust the desired compounds, the ratio, etc.

The user can thus find it to be a particularly interesting palliative to smoking and therefore may reduce or eliminate his tobacco consumption.

For cons, a first drawback of the e-cigarette is the lack of determination of the level of consumption by the user.

With cigarettes, one can count the number of cigarettes and, depending on how a cigarette is smoked, which is generally constant and repeatable for a given smoker, one can determine if consumption is decreasing or increasing.

Even if the accuracy remains limited, it is at least a comparative index, simple and psychologically accessible, even in a state of dependency.

It is also expected to add a special use to the e-cigarette, namely the distillation of medicinal drugs or other active ingredients in the e-liquid. It is the object, for example, of patent application GB-2.466.758. In this case, the determination of the amount of composition that is vaporized, and therefore inhaled, is essential.

The amount of liquid consumed can, of course, be measured using a graduated reservoir but one can quickly understand that accuracy is extremely limited and can only be very vaguely indicative.

Another problem is that of the heating of the composition stored in the reservoir.

Indeed, during vaporization, the temperature necessary to vaporize the composition is high, several hundred degrees on the resistor, and even if the heated mass, that is to say the mass of the resistor, remains low, a significant amount of heat is released.

This local increase in temperature may affect the properties of the e-liquid. These products are vaporized by heat but it was found that the heat had a degrading effect on these products even though they are not yet vaporized.

Now, the heat generated by the resistor at each vaporization is at least partially transmitted by the wick itself to the e-liquid, since the e-liquid therein provides thermal conduction between the vaporization zone and the e-liquid into which is immersed at least one of its ends within the reservoir.

In addition, the e-liquid is also subject to the actions of the heat by transmission through the reservoir wall itself.

This is indicative of a modification of at least some heat-sensitive compounds of the e-liquid under the effect of the heat produced by the heating zone.

This effect is reinforced by the intensive use of the e-cigarette. Intensive use means generating vaporizations with short time intervals, or even continuous use over a period of a few minutes.

In these cases, the resistor itself has no time to return to room temperature. The starting point is therefore already at a high temperature of the resistor receiving a new amount of current so that the maximum temperature increases and can reach over 300° C. by these successive heating pulses. Some users may even keep the switch pressed continuously for a few seconds, resulting also in strong temperature increases, the power consumption not being necessarily a limitation to such use because the batteries have strong capabilities and, in all cases, they are rechargeable or even interchangeable.

It would be useful to be able to move the reservoir away from the e-liquid vaporization zone.

It is also known that the architecture of an e-cigarette provides isolation of the battery from the vaporization chamber so that the e-liquid that may flow from the wick for some reason does not degrade said battery. To this end, a seal is provided to let the power wires pass through between the battery and the resistor, said seal having a hole to allow air to be mixed into the vaporized e-liquid, said hole having necessarily a very small diameter so as to prevent the passage of any e-liquid flow. The corollary is the difficulty for the user to draw a “puff” of vaporized e-liquid.

The difficulty is completely surmountable but aspiration is more difficult than on a cigarette. A problem encountered by the e-cigarette is the necessary suction force because it is currently 2.5 times higher than that of cigarettes.

Indeed, in order to suck, a strong aspiration must be exercised, which, instead of making the use of an e-cigarette pleasant, causes fatigue quite rapidly.

This can be an obstacle or cause a certain weariness and thus lead the user to return to cigarettes, which goes against one of the goals sought.

One solution would be to remove all obstacles with a seal between the vaporization zone comprising the resistor and an air inlet area, especially if a specific air inlet area is provided.

Patent application FR-3,011,718 discloses an arrangement comprising means for metering the volume of inhaled gas adapted to, alternately, allow the vaporization of the liquid substance when the gas concentration in a vaporized substance is less than a predetermined value, and to inhibit said vaporization when the gas concentration in a vaporized liquid substance reaches said predetermined value.

This solution, based on a volumetric measurement, remains inadequate because it is not possible to accurately measure and control the amount of molecules diffused.

### SUMMARY OF THE INVENTION

An object of the present invention is to provide a device which overcomes the disadvantages of the prior art and which provides an e-cigarette perfectly adapted to the user, this also with a simplified arrangement by limiting the heating of the e-liquid, by favoring aspiration, by dosing perfectly and by controlling the diffusion.

### BRIEF DESCRIPTION OF THE DRAWINGS

The controlled feeding device of an e-cigarette according to the present invention is now described according to a particular embodiment, non-limiting, with reference to the accompanying drawings in which the various figures show:

FIG. 1: a schematic view of an e-cigarette according to the present invention, and

FIG. 2: an exploded view of a micro piezoelectric pump.

### DETAILED DESCRIPTION OF THE PREFERRED EMBODIMENTS

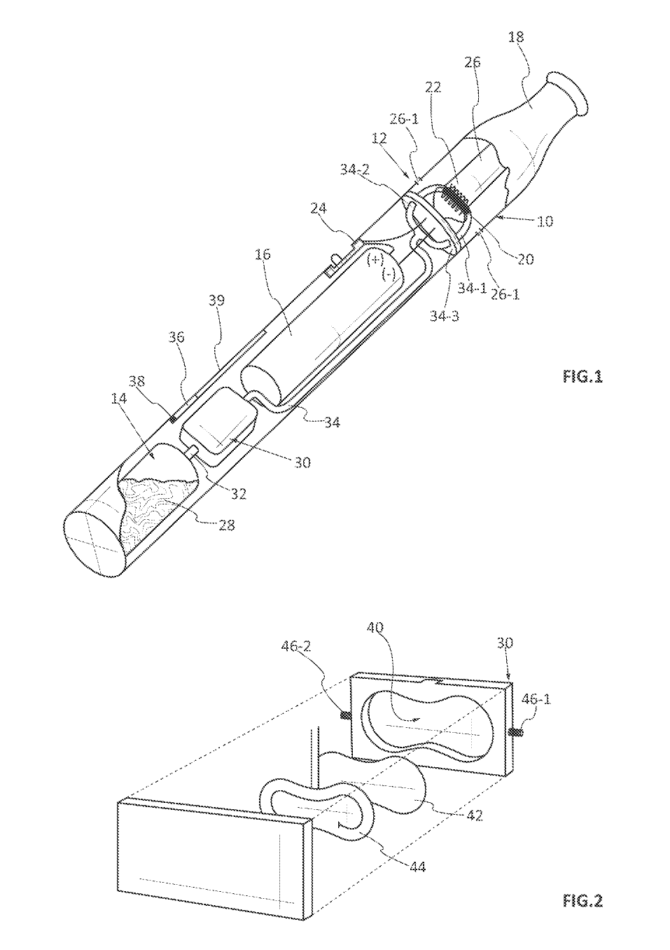

The invention is now described according to FIG. 1.

The controlled feeding device of a wick into an e-cigarette according to the present invention which comprises, in known manner, all arranged in a casing 10: at least a vaporization zone 12, a reservoir 14, a battery 16 and a mouthpiece 18.

The vaporization zone 12 includes a wick 20 surrounded by a resistor 22, of the metal type, with a small diameter in order to heat up when said resistor is adequately electrically powered by the battery 16. In a known arrangement, the resistor is connected to the batteries with power wires. A switch 24 completes the arrangement of the vaporization zone, said switch being positioned anywhere on the casing 10, the only constraint being its accessibility from the outside by the user.

This switch allows controlling the heating of the resistor by current draw.

This vaporization zone 12 is generally crossed by a chimney 26 which connects the vaporization zone and the mouthpiece.

Upstream of the vaporization zone, always considering the upstream/downstream direction as that of the airflow as the user is applying suction, it is possible to provide an inlet zone 26-1, comprising holes or slots. This area is located immediately upstream of the vaporization zone, therefore, in the arrangement shown, downstream of the battery 16.

In the arrangement according to the present invention, a reservoir 14 is provided in a known manner, but is located distally of the casing 10, completely upstream.

The reservoir 14 is intended to contain the e-liquid 28.

The architecture is therefore a novel way with the mouthpiece, the vaporization zone, the battery and the reservoir, or even with an inlet zone downstream of the battery and upstream of the vaporization zone.

The wick 20, located in the vaporization zone with its resistor, is thus remote from the reservoir 14 and the e-liquid 28 contained therein.

A micro pump 30 is interposed between the vaporization zone 12 and the reservoir 14.

This micro pump 30 is advantageously interposed between the reservoir 14 and the battery 16.

A first duct 32 connects said micro pump 30 to the reservoir 14 and a second duct 34 connects the micro pump 30 to the wick 20.

Advantageously, the second duct 34 splits close to said wick into a sub-duct 34-1 and a sub-duct 34-2. Each of these sub-ducts is in connected to a corresponding end of said wick 20. Such connection is advantageously obtained by crimping.

The wick could only be supplied by one end, the other end constituting a fastening on the wall of the chimney, for example.

An optional seal 34-3 may be provided between the vaporization zone and the battery. This seal prevents the accidental flow of the e-liquid from the wick. In this case, the risk is very limited since the e-liquid dosing process is managed and controlled. The risk of overflowing capillarity effects, linked to the temperature, pressure etc., are strongly limited.

The micro pump 30 is also associated with an electronic card 36 comprising a microprocessor 38 so as to calculate the amount of e-liquid distributed, its flow and daily consumption, and to identify any necessary or additional information needed through adequate connections such as, for example, the battery charge, the temperature, the duration of use, the need to change the wick or to warn the user of a too-aggressive pulling, etc.

It is possible to also provide means of communication to connect the electronic board 36 to display and external programming devices in order to drive said micro pump, such as, for example, a mobile phone, a computer, a tablet or a watch. It is then possible to program the e-cigarette easily. Similarly, a screen 39 allows viewing.

The micro pump 30 is energized by the battery 16, same as the resistor.

Many types of pumps are suitable which include diaphragm, electrostatic, electromagnetic, thermo-pneumatic, phase change, bimetallic or shape memory alloy micro pumps.

However, a pump particularly suitable for the present invention is a piezoelectric diaphragm pump which is schematically shown in FIG. 2.

This micro pump comprises a chamber 40 of which one wall is a diaphragm 42, which is itself moved by a piezo 44 which vibrates and sets said diaphragm in motion. Inlet valves 46-1 and output valves 46-2 close the chamber. These valves are unidirectional and open and close in opposition, so that:
when the diaphragm moves away from the wall of the chamber, the outlet valve is closed and the inlet valve from the first duct is open to ensure filling.
when the diaphragm approaches the wall of the chamber, it pushes the e-liquid of the chamber in the second duct because the inlet valve is closed and the outlet valve is opened.

Such micro piezoelectric pumps are very small, for example 30 mm×15 mm×3.8 mm, and consume little energy, i.e., less than 200 mW.

The flow of such a pump is adjustable through a frequency control since the diaphragm is driven with a greater or lesser frequency and therefore the number of fills of the chamber, defined by the membrane per unit of time, determines the flow rate.

It is observed that the e-liquid dosage is thus perfectly controlled and it is possible to measure the volume of the e-liquid dispensed, but also to program it.

Since the reservoir is provided in the preferred arrangement in the lower part of the casing 10, the e-liquid does not have to undergo the heat peaks of the vaporization zone.

Finally, it is observed that the suction-related problems, caused by the seal, no longer arise since the suction can be achieved by an air intake to the right of the vaporization chamber. It suffices then to seal the passage of the second duct to isolate the vaporization zone from the part of the casing 10 containing the battery, which does not affect the suction by the user.

It should be noted that this seal can be removed in favor of a micro pump pilot. Indeed, when the pump has finished feeding the wick with a given dose, it is possible to electrically power the micro pump with a reverse polarity, in the case of a micro engine for example, and, in the case of a micro piezoelectric pump, it is possible to control the valves to reverse their opening or closing directions, this requiring the provision of solenoid valves. In this case, the effect is twofold because it prevents the accumulation of excess e-liquid in the wick, and therefore any accidental unwanted flow, and the sucking action causes the formation of an air bubble between the wick and the e-liquid, prohibiting, on the one hand, the conduction of heat by the wick from the vaporization chamber to the e-liquid in the reservoir, and, on the other hand, allowing it to the e-liquid contained in the duct(s) 34.

The micro pump can be located anywhere in the casing 10 without changing the present invention, other than on the right to the vaporization zone.

Thus, the issues raised in the prior art should be solved in the case of the positioning of the reservoir 14 and the micro pump 30 of e-liquid 28 between the battery 16 and the vaporization zone 12, or also of only the micro pump between the vaporization zone and the battery with the reservoir in the lower portion, upstream of the battery, the key condition being having the reservoir out of the vaporization zone.

The invention also covers the e-cigarette which comprises a casing 10, and, in a downstream-upstream sequence, a mouthpiece 18, a vaporization zone 12, a chimney 26 connecting said vaporization zone and said mouthpiece, a battery 16, a micro pump 30 and a reservoir 14 of e-liquid 28.

Alternatively, the invention covers the e-cigarette which comprises a casing 10, and, in a downstream-upstream sequence, a mouthpiece 18, a vaporization zone 12, a chimney 26 connecting said vaporization zone and said mouthpiece, a micro pump 30, a reservoir 14 of e-liquid 28, and a battery 16.

Alternatively, the invention covers the e-cigarette which comprises a casing 10, and, in a downstream-upstream sequence, a mouthpiece 18, a vaporization zone 12, a chimney 26 connecting said vaporization zone and said mouthpiece, a micro pump 30, a battery 16 and a reservoir 14 of e-liquid 28.

Advantageously, the casing 10 may have a touch screen or screen with menus to directly program the e-cigarette.

It should be noted that the arrangement of the present invention allows eliminating the need for a joint in the chimney, immediately upstream of the vaporization zone.

The suction by the user is thus enhanced.

The e-liquid in the reservoir is no longer subjected to the recurrent heat from the vaporization zone.

The feeding of the wick is metered and controlled.

It should be noted that the vaporization zone has been described with a wick and a resistor, but the heating means may vary and be induction heating or any other heating means.

Similarly, a micro pump with ducts was described, but the micro pump may also be immersed, the ducts then being strongly limited or even nonexistent.

The user can fully control and check his e-liquid consumption.

The arrangement is therefore particularly suitable for promoting the use of e-cigarettes, either as a palliative to smoking, or as a playful and fun device in its own right.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A feeding device of an e-cigarette in e-liquid, comprising:
a vaporization zone with at least one wick and a resistor,
a reservoir of e-liquid,
a battery for supplying at least said resistor,
at least one micro pump interposed between the reservoir and the wick so as to at least one of control and dose the e-liquid.

2. The feeding device of an e-cigarette in e-liquid according to claim 1, wherein the micro pump is connected to the wick by a split duct, the two sub-ducts respectively supplying both ends of the wick.

3. The feeding device of an e-cigarette in e-liquid according to claim 1, wherein the micro pump is a piezoelectric pump.

4. The feeding device of an e-cigarette in e-liquid according to claim 1, further comprising an electronic card for driving the micro pump.

5. The feeding device of an e-cigarette in e-liquid according to claim 4, wherein the electronic card is programmable.

6. The feeding device of an e-cigarette in e-liquid according to claim 4, wherein the electronic card is connected to external devices for visualization and programming.

7. An e-cigarette incorporating the feeding device according to claim 1, further comprising a casing, and, in a downstream to upstream sequence, a mouthpiece, a vaporization zone, a chimney connecting said vaporization zone and said mouthpiece, a battery, a micro pump and a reservoir of e-liquid.

8. The e-cigarette incorporating the feeding device according to claim 1, further comprising a casing, and, in a downstream to upstream sequence, a mouthpiece, a vaporization zone, a chimney connecting said vaporization zone and said mouthpiece, a micro pump, a battery and a reservoir of e-liquid.

9. The e-cigarette incorporating the device according to claim 1, further comprising a casing, and, in a downstream to upstream sequence, a mouthpiece, a vaporization zone, a chimney connecting said vaporization zone and said mouthpiece, a micro pump, a reservoir of e-liquid and a battery.

10. The e-cigarette incorporating the device according to claim 7, further comprising a switch for controlling the resistor.

11. The e-cigarette incorporating the device according to claim 7, further comprising an electronic board for controlling the micro pump and a screen for displaying information related to said card.
